(19) United States
(12) Patent Application Publication
(10) Pub. No.: US 2026/0018990 A1
(43) Pub. Date: Jan. 15, 2026

(54) CONFIGURABLE POWER CONVERTER

(71) Applicant: Cummins Power Generation Inc., Minneapolis, MN (US)

(72) Inventors: Veda Samhitha Duppalli, Fridley, MN (US); Denise Maria Christine Athaide, Minneapolis, MN (US); Justin J. Moe, Forest Lake, MN (US); Wangwei Zhou, Shoreview, MN (US); Subbarao Dakshina Murthy-Bellur, Minneapolis, MN (US); Brian Thorvald Olson, Ramsey, MN (US); Minyu Cai, West Lafayette, IN (US)

(73) Assignee: Cummins Power Generation Inc., Minneapolis, MN (US)

(21) Appl. No.: 18/993,857

(22) PCT Filed: Jul. 14, 2022
(86) PCT No.: PCT/US2022/037188

§ 371 Date: Jan. 13, 2025

(51) Int. Cl. H02M 1/10; H02M 1/44; H02M 7/539

(52) U.S. Cl. CPC H02M 1/10; H02M 1/44; H02M 7/539

(57) ABSTRACT

Disclosed herein are related to a configurable power converter to convert between a direct current (DC) voltage and an alternating current (AC) voltage. In one aspect, the configurable power converter includes a first set of switches coupled to a first set of ports, a set of filter components, and a second set of switches. In one aspect, the configurable power converter includes a controller configured to: receive a configuration signal indicating a selected configuration mode of the configurable power converter, enable a subset of the second set of switches, according to the configuration signal, and apply periodic pulses to the first set of switches to generate one or more AC voltages at one or more of the second set of ports, according to the configuration signal.

### TECHNICAL FIELD

The present application relates generally to systems and methods for converting between direct current (DC) power and alternating current (AC) power.

### BACKGROUND

A power converter can convert a DC voltage into an AC voltage to power other electrical components. For example, computers, televisions, speakers, electric light sources, refrigerators, or various electronic devices can receive the AC voltage (100V-220V) from the power converter, and operate based on the AC voltage received. Different power converters can output different AC voltages, depending on a number of output ports, specific voltages or frequencies of the AC voltages to supply, loading conditions, etc. For example, one power converter can output a single phase 120V/240 AC voltage at two output ports, where another power converter can output a three-phase 139V/240 AC voltage at three output ports. In some cases, a power converter can be rearranged or reconfigured to supply power with a different AC voltage or to supply power to a different number of ports by manually replacing hardware components such as a transformer, inductors with different windings, electrical connections, or any combination of them. However, identifying and obtaining suitable hardware components for a desired AC voltage can be cumbersome. Moreover, manually replacing hardware components involves a laborious process, which can be time consuming and subject to human errors.

### SUMMARY

Disclosed herein are related to a configurable power converter for adaptively converting between a direct current (DC) power and an alternating current (AC) power or between a DC voltage and an AC voltage. In some embodiments, the configurable power converter includes a first set of switches coupled to a first set of ports. In some embodiments, the configurable power converter includes a set of filter components coupled to a second set of ports. In some embodiments, the configurable power converter includes a second set of switches. In some embodiments, each of the second set of switches is coupled to a corresponding one of the set of filter components or a corresponding one of the second set of ports. In some embodiments, the configurable power converter includes a controller. In some embodiments, the controller is configured to receive a configuration signal indicating a selected configuration mode of the configurable power converter. In some embodiments, the controller is configured to enable a subset of the second set of switches, according to the configuration signal. In some embodiments, the controller is configured to and apply periodic pulses to the first set of switches to generate one or more AC voltages at one or more of the second set of ports, according to the configuration signal.

In one aspect, the controller is configured to disable another subset of the second set of switches, according to the configuration signal, and apply the periodic pulses to the first set of switches, while the subset of the second set of switches is enabled and the another subset of the second set of switches is disabled.

In one aspect, the selected configuration mode is selected from two or more of: a first configuration mode, in which two pairs of the first set of switches are periodically toggled to provide a single phase AC voltage at two ports of the second set of ports, a second configuration mode, in which the two pairs of the first set of switches are periodically toggled to provide a two-phase AC voltage at three ports of the second set of ports, a third configuration mode, in which three pairs of the first set of switches are periodically toggled to provide another two-phase AC voltage at the three ports of the second set of ports, and a fourth configuration mode, in which the three pairs of the first set of switches are periodically toggled to provide a three-phase AC voltage at the three ports of the second set of ports.

In one aspect, the selected configuration mode is selected from two or more of: a first configuration mode, in which first two pairs and second two pairs of the first set of switches are periodically toggled to provide a single phase AC voltage at first two ports of the second set of ports and another single phase AC voltage at second two ports of the second set of ports, and a second configuration mode, in which the first two pairs and the second two pairs of the first set of switches are periodically toggled to provide a three-phase AC voltage at the first two ports and the second two ports of the second set of ports.

In one aspect, the configurable power converter includes an input device configured to receive a user selection of the selected configuration mode from one or more allowable configuration modes, and generate the configuration signal indicating the selected configuration mode, according to the user selection.

In one aspect, the configurable power converter includes a communication interface configured to receive, from a remote device, a configuration message indicating the selected configuration mode, and decode the configuration message to generate the configuration signal.

In one aspect, the first set of switches includes: a first switch coupled between a first input port of the first set of ports and a first node, a second switch coupled between a second input port of the first set of ports and the first node, a third switch coupled between the first input port and a second node, a fourth switch coupled between the second input port and the second node, a fifth switch coupled between the first input port and a third node, and a sixth switch coupled between the second input port and the third node.

In one aspect, the set of filter components includes a first inductor coupled between the first node and a first output port of the second set of ports, a second inductor coupled between the second node and a second output port of the second set of ports, and a third inductor coupled between the third node and a third output port of the second set of ports.

In one aspect, the configurable power converter includes a first capacitor coupled between the first input port and a fourth node, a second capacitor coupled between the second input port and the fourth node, a third capacitor coupled between the first output port and the third output port, a fourth capacitor coupled between the second output port and the third output port, and a fifth capacitor coupled between the first output port and the second output port.

In one aspect, the second set of switches includes a first configuration switch coupled between the third node and a first end of the third inductor, a second configuration switch coupled between the fourth node and the first end of the third inductor, a third configuration switch coupled between the third output port and a second end of the third inductor, and a fourth configuration switch coupled between the first output port and the second output port in series with the fifth capacitor.

In one aspect, the configurable power converter includes a first capacitor coupled between the first input port and a fourth node, a second capacitor coupled between the second input port and the fourth node, a third capacitor coupled between the first output port and a fifth node, a fourth capacitor coupled between the second output port and the fifth node, and a fifth capacitor coupled between the third output port and the fifth node.

In one aspect, the second set of switches includes a first configuration switch coupled between the third node and a first end of the third inductor, a second configuration switch coupled between the first end of the third inductor and the fourth node, a third configuration switch coupled between the fourth node and the fifth node, a fourth configuration switch coupled between the third output port and the fifth node in series with the fifth capacitor, a fifth configuration switch coupled between the second output port and the fifth node in series with the fourth capacitor, a sixth configuration switch coupled between the third output port and the fifth node, and a seventh configuration switch coupled between the first output port and the fifth node in series with the third capacitor.

In one aspect, the first set of switches includes a first switch coupled between a first input port of the first set of ports and a first node, a second switch coupled between a second input port of the first set of ports and the first node, a third switch coupled between the first input port and a second node, a fourth switch coupled between the second input port and the second node, a fifth switch coupled between the first input port and a third node, a sixth switch coupled between the second input port and the third node, a seventh switch coupled between the first input port and a fourth node, and an eighth switch coupled between the second input port and the fourth node.

In one aspect, the set of filter components includes a first inductor coupled between the first node and a first output port of the second set of ports, a second inductor coupled between the second node and a second output port of the second set of ports, a third inductor coupled between the third node and a third output port of the second set of ports, and a fourth inductor coupled between the fourth node and a fourth output port of the second set of ports.

In one aspect, the configurable power converter includes a first capacitor coupled between the first input port and the second input port, a second capacitor coupled between the first output port and a fifth node, a third capacitor coupled between the second output port and the fifth node, and a fourth capacitor coupled between the third output port and the fourth output port. In one aspect, the second set of switches includes a configuration switch coupled between the fourth output port and the fifth node.

In one aspect, the configurable power converter is coupled to a DC power source at the first set of ports. In one aspect, the configurable power converter is configured to receive a DC voltage from the DC power source at the first set of ports, and provide the one or more AC voltages to a load at the one or more of the second set of ports.

In one aspect, the configurable power converter is coupled to a generator set at the second set of ports. In one aspect, the configurable power converter is configured to receive an AC voltage at the second set of ports, and provide a DC voltage to a battery at the first set of ports, according to the configuration signal.

In one aspect, the controller is configured to set a frequency of the pulses, according to the configuration signal.

In one aspect, the configurable power converter includes a sensor device configured to monitor a voltage or current at one or more of the first set of ports or one or more of the second set of ports. In one aspect, the controller is configured to perform calibration, protection, diagnostic, or metering, according to the monitored voltage or current.

Various embodiments disclosed herein are related to a method of converting between a direct current (DC) power and an alternating current (AC) power by a configurable power converter. In some embodiments, the configurable power converter includes a set of switches, a set of contactors, a set of filter components, and a controller. In some embodiments, the method includes receiving, by a first set of ports of the configurable power converter coupled to the set of switches, a DC voltage. In some embodiments, the method includes receiving, by the controller, a configuration signal indicating a selected configuration mode of the configurable power converter. In some embodiments, the method includes configuring, by the controller, the set of contactors, according to the configuration signal. Configuring the set of contactors can include enabling a first subset of the set of contactors and disabling a second subset of the set of contactors. In some embodiments, the method includes toggling, by the controller, the set of switches to generate one or more AC voltages at one or more of a second set of ports, while the set of contactors are configured according to the configuration signal.

In one aspect, the method includes setting, by the controller, a frequency of pulses to toggle the set of switches, according to the configuration signal.

In one aspect, the method include monitoring, by a sensor device, a voltage or current at one or more of the first set of ports or one or more of the second set of ports. In one aspect, the method includes performing, by the controller, a calibration, a protection, a diagnostic, or a metering, according to the monitored voltage or current.

Various embodiments disclosed herein are related to a system for adaptively providing an alternating current (AC) power based on a direct current (DC) power. In some embodiments, the system includes a generator set configured to generate, in a charging mode, an AC voltage at one or more ports. In some embodiments, the system includes a power conversion device coupled to the generator set at the one or more ports. In some embodiments, the power conversion device is configured to generate, in a DC-AC conversion mode, one or more AC voltages at the one or more ports, according to a selected configuration mode, based on a DC voltage from a DC power source. In some embodiments, the power conversion device is configured to charge, in a charging mode, the DC power source based on the AC voltage from the generator set at the one or more ports.

In one aspect, the power conversion device includes a first set of switches, a second set of switches, and a controller. In one aspect, the controller is configured to enable a subset of the second set of switches. In one aspect, the controller is configured to apply periodic pulses to the first set of switches to charge the DC power source, while the subset of the second set of switches is enabled.

Various embodiments disclosed herein are related to a method of converting between a DC voltage and an AC voltage by a configurable power converter. In some embodiments, the configurable power converter includes a first set of switches, a second set of switches, a set of filter components, and a controller. In some embodiments, the method includes receiving, by a first set of ports of the configurable power converter coupled to the first set of switches, the DC voltage. In some embodiments, the method includes receiving, by the controller, a configuration signal indicating a selected configuration mode of the configurable power converter. In some embodiments, the method includes enabling, by the controller, a subset of the second set of switches, according to the configuration signal. In some embodiments, each of the second set of switches is coupled to a corresponding one of the set of filter components or a corresponding one of a second set of ports of the configurable power converter. In some embodiments, the method includes applying, by the controller, periodic pulses to the first set of switches to generate one or more AC voltages at one or more of the second set of ports, according to the configuration signal.

In one aspect, the method includes disabling another subset of the second set of switches, according to the configuration signal, and applying, by the controller, the periodic pulses to the first set of switches, while the subset of the second set of switches is enabled and the another subset of the second set of switches is disabled.

In one aspect, the selected configuration mode is selected from two or more of: a first configuration mode, in which two pairs of the first set of switches are periodically toggled to provide a single phase AC voltage at two ports of the second set of ports, a second configuration mode, in which the two pairs of the first set of switches are periodically toggled to provide a two-phase AC voltage at three ports of the second set of ports, a third configuration mode, in which three pairs of the first set of switches are periodically toggled to provide another two-phase AC voltage at the three ports of the second set of ports, and a fourth configuration mode, in which the three pairs of the first set of switches are periodically toggled to provide a three-phase AC voltage at the three ports of the second set of ports.

In one aspect, the selected configuration mode is selected from two or more of: a first configuration mode, in which first two pairs and second two pairs of the first set of switches are periodically toggled to provide a single phase AC voltage at first two ports of the second set of ports and another single phase AC voltage at second two ports of the second set of ports, and a second configuration mode, in which the first two pairs and the second two pairs of the first set of switches are periodically toggled to provide a three-phase AC voltage at the first two ports and the second two ports of the second set of ports.

In one aspect, the method includes receiving, by a communication interface, a configuration message indicating the selected configuration mode, and decoding, by the communication interface, the configuration message to generate the configuration signal.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of an example system including a power conversion device with a configurable power converter;

FIG. 2 is a schematic diagram of a configurable power converter;

FIG. 3 is a schematic diagram of a generator set;

FIG. 4 is a schematic diagram of a configurable power converter circuit;

FIGS. 5-8 show the configurable power converter circuit of FIG. 4 operating in different configuration modes;

FIG. 9 is a schematic diagram of a configurable power converter circuit;

FIGS. 10-13 show the configurable power converter circuit of FIG. 9 operating in different configuration modes;

FIG. 14 is a schematic diagram of a configurable power converter circuit;

FIGS. 15 and 16 show the configurable power converter circuit of FIG. 14 operating in different configuration modes; and

FIG. 17 shows a method of adaptively converting between DC power and AC power.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

### Overview

Following below are more detailed descriptions of various concepts related to, and implementations of, methods, apparatuses, and for implementing a power converter. The various concepts introduced above and discussed in greater detail below can be implemented in any of numerous ways, as the described concepts are not limited to any particular manner of implementation. Examples of specific implementations and applications are provided primarily for illustrative purposes.

Disclosed herein are related to a configurable power converter to convert between a DC voltage and one or more AC voltages. The power converter can operate as a DC-AC power converter, an AC-DC power converter, or both. In one aspect, the configurable power converter includes a first set of switches coupled to a first set of ports, a set of filter components coupled to a second set of ports, and a second set of switches. Examples of the filter components include inductors, capacitors, resistors, or any electrical components. In a DC-AC conversion mode, the first set of ports can be input ports and the second set of ports can be output ports. In an AC-DC conversion mode (or in a charging mode), the second set of ports can be input ports and the first set of ports can be output ports. The first set of switches can be switches that can be periodically toggled to convert a DC voltage into one or more AC voltages or convert one or more AC voltages into a DC voltage. The second set of switches can be switches to electrically arrange the first set of switches, the set of filter components and other components of the configurable power converter, according to a selected configuration mode. In one aspect, the configurable power converter includes a controller. The controller is configured to receive a configuration signal indicating a selected configuration mode of the configurable power converter. According to the configuration signal, the controller is configured to enable a subset of the second set of switches, and apply periodic pulses to the first set of switches to generate one or more AC voltages based on a DC voltage received, or to generate a DC voltage based on one or more AC voltages received.

Advantageously, the configurable power converter can be arranged or operate in different modes according to the configuration signal in a simple manner. In one aspect, the configurable power converter includes or is coupled to an input device that can generate the configuration signal. The input device can be a button, a turn dial, a touch pad, a touch display device, a set of switches, or any device that can generate an electrical signal according to a user selection. The input device allows a user to select a configuration mode of the configurable power converter, and generates the configuration signal indicative of the selected configuration mode. According to the configuration signal, a subset of the second set of switches can be enabled and another subset of the second set of switches can be disabled to electrically arrange the first set of switches, the set of filter components and other components of the configurable power converter in the selected configuration mode. By electrically arranging the configurable power converter according to the configuration signal, manually identifying and replacing hardware components of a power converter to change a configuration mode can be obviated.

In one aspect, a configurable power converter can be set or controlled by another device. For example, the configurable power converter includes a communication interface that can communicate with a remote server or a user device. For example, a user device (e.g., smart phone, desktop computer, laptop, table PC, or any computing device) operated by a user can transmit, to the configurable power converter, a configuration message. The configuration message is a signal indicating the selected configuration mode. Additionally or alternatively, the remote server can generate the configuration message, and transmit the configuration message to the configurable power converter. The communication interface can decode the configuration message to generate the configuration signal according to the selected configuration mode indicated by the configuration message. The communication interface can provide the configuration signal to the controller. According to the configuration signal, a subset of the second set of switches can be enabled and another subset of the second set of switches can be disabled to electrically arrange the first set of switches, the set of filter components and other components of the configurable power converter in the selected configuration mode. Accordingly, the configurable power converter can be adaptively utilized for different devices or systems by setting or controlling the configuration mode of the configurable power converter through a remote device.

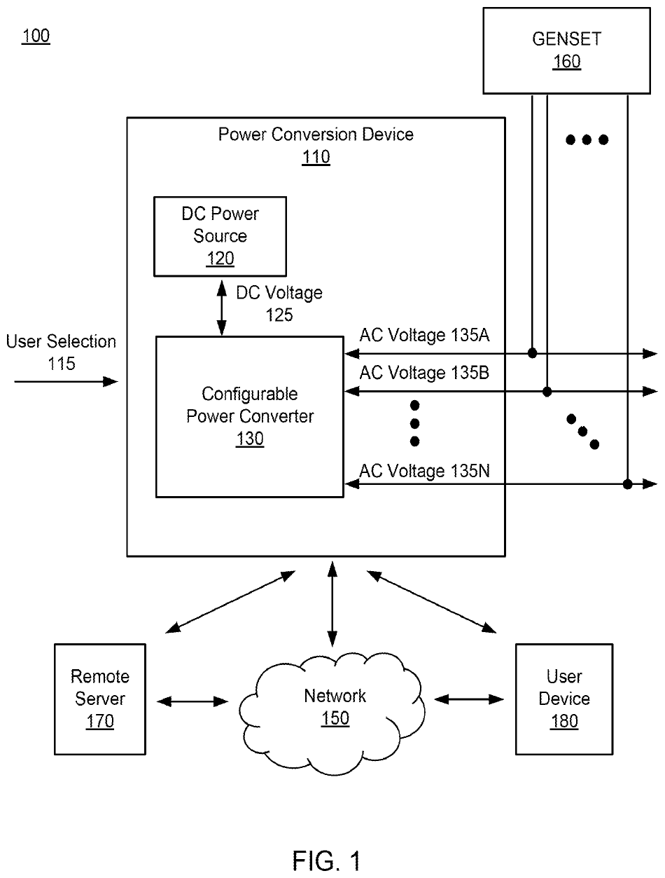

FIG. 1 is a block diagram of an example system 100 including a power conversion device 110 with a configurable power converter system 130 (also referred to as “a configurable power converter 130” herein), a remote server 170, a user device 180, and a generator set 160 (also referred to as “a genset 160”). The power conversion device 110 can receive a user selection 115 of a configuration mode of the configurable power converter 130, and generate one or more AC voltages 135, according to the user selection 115. Additionally or alternatively, the power conversion device 110 can receive, from the remote server 170, the user device 180, or both through a network 150, a message or an instruction indicating the configuration mode, and generate one or more AC voltages 135 according to the received message or instruction. In some embodiments, the system 100 includes more, fewer, or different components than shown in FIG. 1. For example, in some embodiments, the system 100 includes additional user devices 180, includes additional remote servers 170, includes additional electronic devices, lacks the remote server 170, lacks the user device 180, or any combination of them. For example, in some embodiments, the system 100 lacks the remote server 170, the user device 180 or the genset 160.

The network 150 is a communication medium, through which the configurable power converter 130, the remote server 170, and the user device 180 can communicate with each other. Examples of the network 150 include a wireless network (e.g., Wi-Fi, Bluetooth, cellular network, etc.), a wired network (e.g., Ethernet, USB, etc.), or a combination of the wireless network and the wired network.

In some embodiments, the power conversion device 110 is any electronic device that generates different AC voltages 135A . . . 135N for different configuration modes. For example, the power conversion device 110 can be a portable power generator. The power conversion device 110 can be connected to any electrical load, an AC source, a micro grid, a utility grid, or a power grid, and provide AC voltages 135A . . . 135N to the electrical load or the power grid. In some embodiments, the power conversion device 110 includes a DC power source 120 and the configurable power converter 130. In some embodiments, the DC power source 120 is a battery or any electric component that can provide the DC voltage 125. The configurable power converter 130 is a component that receives the DC voltage 125 from the DC power source 120, and generates different AC voltages 135 for different configuration modes. Examples of configuration modes include: 2-leg 1-ph 2-wire, 2-leg 2-ph (split-phase) 3-wire, 3-leg 2-ph (split-phase) 3-wire, 3-leg 3-ph 3-wire 208VRMS (balanced load), 3-leg 3-ph 3-wire 480VRMS (balanced load), 2×2-leg 1-ph 2-wire, 4-leg 3-ph 4-wire 208VRMS (unbalanced load), 4-leg 3-ph 4-wire 480VRMS (unbalanced load). The configurable power converter 130 can generate one or more AC voltages 135, according to a selected configuration mode as indicated by the user selection 115 or a message or instruction from a remote device. The configurable power converter 130 can provide one or more AC voltages 135 to external devices, or internal components of the power conversion device 110.

In some embodiments, the power conversion device 110 can convert one or more AC voltages 135 into a DC voltage 125. In one configuration, the power conversion device 110 can be connected to the genset 160. In some embodiments, the power conversion device 110 can be connected to any load, an AC source, a micro grid, a utility grid, or any combination of them. The power conversion device 110 can receive one or more AC voltages 135 from the genset 160, and convert the one or more AC voltages 135 into a DC voltage 125 to charge the DC power source 120 or battery. When charging the DC power source 120 or the battery, the configurable power converter 130 can generate the DC voltage 125 based on one or more AC voltages 135 from the genset 160, according to a selected configuration mode as indicated by the user selection 115 or a message or instruction from a remote device.

In some embodiments, the user device 180 is a computing device operable by a user. The user device 180 can be a smart phone, a computer, a laptop, a tablet PC, or any electronic device for setting a configuration mode of the power conversion device 110. The user device 180 can include one or more processors, and a storage medium (e.g., non-transitory computer readable medium) that stores instructions when executed by the one or more processors cause the one or more processors to perform various functions for setting the configuration mode of the power conversion device 110. The user device 180 can include a communication interface to communicate with the remote server 170, the power conversion device 110 or both through the network 150. In one example, the user device 180 presents, through a graphical user interface, a list of allowable configuration modes, and allows the user to select a selected configuration mode. In response to the user selection, the user device 180 can generate a configuration message. The configuration message is a signal indicating the selected configuration mode. The user device 180 can transmit the configuration message to the power conversion device 110 through the network 150 to cause the configurable power converter to provide one or more AC voltages 135 according to the configuration message.

In some embodiments, the user device 180 generates the configuration message, in response to an authorization by the remote server 170. In one example, in response to the user selection, the user device 180 generates a request message. The request message is a signal requesting to operate the configurable power converter 130 in a selected configuration mode. The user device 180 can transmit the request message to the remote server 170. In response to the request message, the remote server 170 can generate an authorization message. The authorization message is a signal indicating that the user can configure or operate the configurable power converter 130 in the selected or requested configuration mode. The remote server 170 can transmit the authorization message to the user device 180 that transmitted the request message. In response to the authorization message, the user device 180 can generate the configuration message indicating the selected configuration mode, and transmit the configuration message to the power conversion device 110.

In some embodiments, the remote server 170 is a computer or any electronic device for managing or authorizing a configuration mode of the power conversion device 110. The server 170 can include one or more processors, and a storage medium (e.g., non-transitory computer readable medium) that stores instructions when executed by the one or more processors cause the one or more processors to perform various functions for managing and/or authorizing a configuration mode of the power conversion device 110. The remote server 170 can store, for each user or each power conversion device 110, a corresponding list of allowable configuration modes at a database or the storage medium. The remote server 170 can receive the request message from the user device 180, and determine whether the user is authorized to operate the power conversion device 110 or the configurable power converter 130 in the requested configuration mode indicated by the request message. For example, the remote server 170 can determine whether the requested configuration mode is in the list of allowable configuration modes or is supported by the configurable power converter 130. For example, the remote server 170 can determine whether a payment for such requested configuration mode is approved or not. In response to determining or confirming that the user is authorized to operate the configurable power converter 130 in the requested configuration mode, the remote server 170 can generate the authorization message and transmit the authorization message to the user device 180. Additionally or alternatively, in response to determining or confirming that the user is authorized to operate the configurable power converter 130 in the requested configuration mode, the remote server 170 can generate the mode selection signal and transmit the mode selection signal to the power conversion device 110.

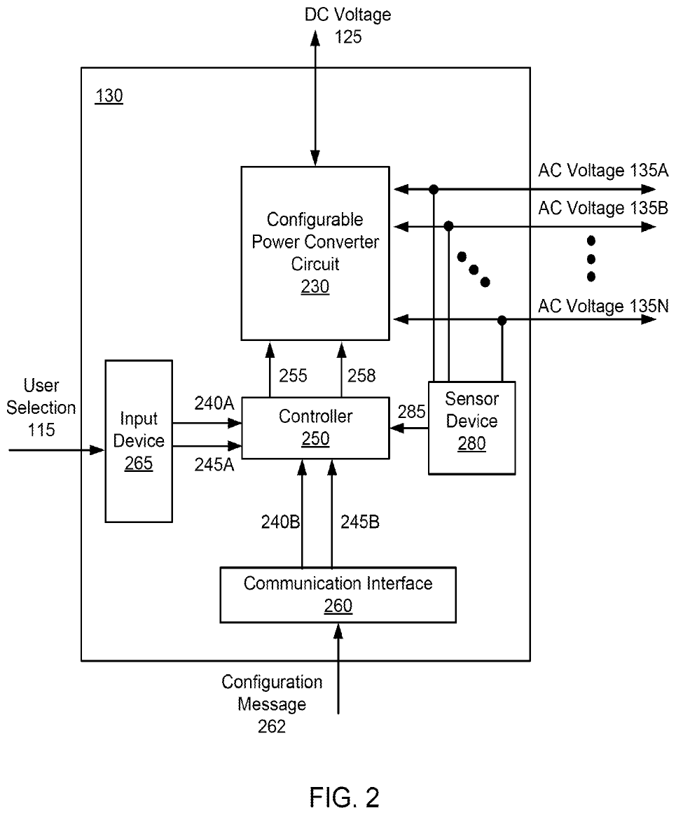

FIG. 2 is a block diagram of the configurable power converter 130. In some embodiments, the configurable power converter 130 includes a configurable power converter circuit 230, an input device 265, a controller 250, and a communication interface 260. These components can operate together to convert between the DC voltage 125 and one or more AC voltages 135, according to the user selection 115 or a configuration message 262. In some embodiments, the configurable power converter 130 includes more, fewer, or different components than shown in FIG. 2.

The input device 265 is a device that receives the user selection 115, and generates a configuration signal 240A according to the user selection 115. The configuration signal 240A is an electrical signal indicating a selected configuration mode of the configurable power converter 130. Examples of the input device 265 include a button, a turn dial, a touch pad, a touch display device, a set of switches, or any device that can generate an electrical signal according to the user selection 115. The user can manually touch, press, or configure the input device 265 to select a desired configuration mode. The input device 265 can generate the configuration signal 240A corresponding to the selected configuration, and output or provide the configuration signal 240A to the controller 250.

In some embodiments, the input device 265 receives the user selection of an operating mode of the configurable power converter 130, and generates an operating mode signal 245A indicating the selected operating mode. An operating mode of the configurable power converter 130 can be selected from a DC-AC conversion mode or an AC-DC conversion mode. In the AC-DC conversion mode, the configurable power converter 130 can provide AC voltages to a power grid or a load device. In the DC-AC conversion mode, the configurable power converter 130 can receive AC voltages, for example, from the genset 160, and charge the DC power source 120 or battery. The input device 265 can generate an operating mode signal 245A corresponding to the selected operating mode, and provide the operating mode signal 245A to the controller 250.

The communication interface 260 is a device that can connect to the network 150 to communicate with the remote server 170, the user device 180, or other devices. The communication interface 260 can receive a configuration message 262 from the remote server 170 or the user device 180, and generate a configuration signal 240B according to the configuration message 262. The configuration signal 240B is an electrical signal indicating a selected configuration mode of the configurable power converter 130. The communication interface 260 can receive the configuration message 262, and downconvert or decode the configuration message 262 to generate the configuration signal 240B. The communication interface 260 can output or provide the configuration signal 240B to the controller 250.

In some embodiments, the communication interface 260 receives the configuration message 262, and generates an operating mode signal 245B indicating the selected operating mode according to the configuration message 262. In one aspect, the configuration message 262 indicates a selected operating mode of the configurable power converter 130. The communication interface 260 can receive the configuration message 262 through the network 150, and downconvert or decode the configuration message 262 to generate the configuration signal 240B. The communication interface 260 can output or provide the configuration signal 240B to the controller 250.

The controller 250 is a device that configures or operates the configurable power converter circuit 230. The controller 250 can be embodied as field programmable gate array (FPGA), application specific integrated circuit (ASIC), or any logic circuit. In one aspect, the controller 250 receives the configuration signal 240A or the configuration signal 240B, and generates pulses 255 and mode control signals 258, according to the configuration signal 240A or the configuration signal 240B. The pulses 255 are periodic signals to toggle on or off one or more switches for converting between the DC voltage 125 and one or more AC voltages 135. The mode control signals 258 are signals for enabling or disabling one or more switches corresponding to a selected configuration mode to arrange various components of the configurable power converter circuit 230 in the selected configuration mode. The controller 250 can determine one or more parameters (e.g., a frequency, a pulse width, and a number of pulses 255 to output, etc.) of the pulses 255, according to a selected configuration mode as indicated by the configuration signal 240A or the configuration signal 240B, and generate the pulses 255 according to the determined parameters. In addition, the controller 250 can determine which switch(es) of the configurable power converter circuit 230 to enable and which switch(es) of the configurable power converter circuit 230 to disable, according to a selected configuration mode as indicated by the configuration signal 240A or the configuration signal 240B. The controller 250 can generate the mode control signals 258, according to the determination on which switches to enable and which switches to disable. The controller 250 can apply the mode control signals 258 to the configurable power converter circuit 230 to electrically arrange various components of the configurable power converter circuit 230 in the selected configuration mode. While various components of the configurable power converter circuit 230 are arranged in the selected configuration mode according to the mode control signals 258, the controller 250 can apply the pulses 255 to the configurable power converter circuit 230 to convert between the DC voltage and the one or more AC voltages 135.

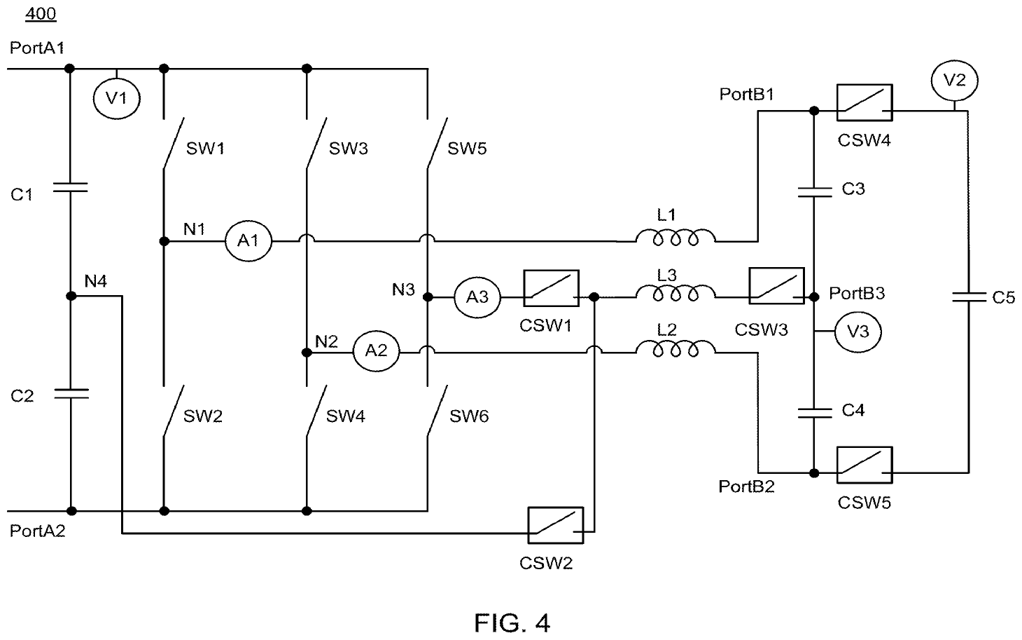

The configurable power converter circuit 230 is a circuit that converts between a DC voltage 125 and one or more AC voltages 135 according to the pulses 255 and the mode control signals 258. In a DC-AC conversion mode, the configurable power converter circuit 230 can receive the DC voltage 125 and generate one or more AC voltages 135. In an AC-DC conversion mode (or in a charging mode), the configurable power converter circuit 230 can receive the one or more AC voltages 135 and generate the DC voltage 125. The configurable power converter circuit 230 includes a first set of ports to receive the DC voltage 125, and a second set of ports to provide or output AC voltages 135A . . . 135N in the DC-AC conversion mode. In one aspect, the configurable power converter circuit 230 includes a first set of switches coupled to the first set of ports, a set of filter components coupled to the second set of ports, and a second set of switches. Examples of the filter components include inductors, capacitors, resistors, or any electrical components. The first set of switches can be switches that can be periodically toggled according to the pulses 255 to convert between the DC voltage 125 and one or more AC voltages 135. The second set of switches can be switches to electrically arrange the first set of switches, the set of filter components and other components of the configuration power converter circuit 230, according to the mode control signals 258. Detailed description on example configurations of the configurable power converter circuit 230 is provided below with respect to FIGS. 4-16.

In some embodiments, the configurable power converter circuit 230 includes or is coupled to the sensor device 280. The sensor device 280 can include one or more voltage sensors, one or more current sensors, or a combination of them coupled to various components of the configurable power converter circuit 230. For example, the sensor device 280 can sense current or AC voltages 135 at one or more of the first set of ports, one or more of the second set of ports, or a combination of them. The sensor device 280 can generate sensor measurements 285 indicating the sensed current or AC voltages 135. The controller 250 can receive the sensor measurements 285 and perform calibration, protection, diagnostic, metering, or a combination of them, according to the sensor measurements. For example, the controller 250 can verify that characteristics of power delivered (e.g., number of legs, number of phases, AC output voltage, pulse width, frequency, etc.) are consistent with the user selection 115 or the configuration message 262. For example, the controller 250 can compare the current or the AC voltages 135 indicated by the sensor measurements 285 against target values, and adjust one or more parameters (e.g., a frequency, a pulse width, and a number of pulses 255 to output, etc.) of the pulses 255 and/or the mode control signal 258, such that the current or the AC voltages 135 can be modified to be close to the target values. In one aspect, different calibrations, protections, diagnostics, or metering can be performed for different configuration modes. The controller 250 may determine the selected configuration mode, and automatically perform a calibration, protection, diagnostic, or metering corresponding to the selected configuration mode.

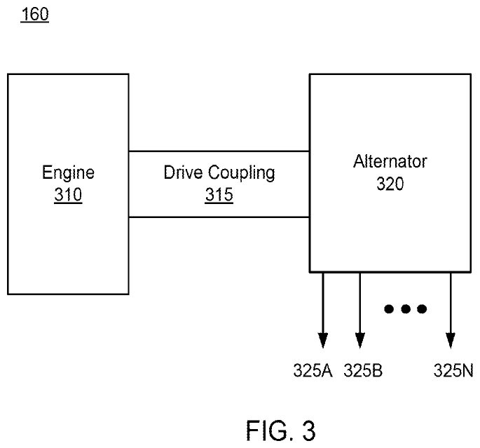

FIG. 3 is a schematic diagram of a genset 160. The genset 160 can include an engine 310, a drive coupling 315, and an alternator 320. These components may operate together to generate the DC voltage 125. In some embodiments, the genset 160 includes more, fewer, or different components than shown in FIG. 3.

In some embodiments, the engine 310 is a machine or a mechanical component that generates mechanical energy or mechanical force. In one configuration, the engine 310 is coupled to the alternator 320 through a drive coupling 315. In some embodiments, the drive coupling 315 is a mechanical component or a shaft that rotates, according to the mechanical force generated by the engine 310. The engine 310 can generate the mechanical force to rotate the drive coupling 315 based on combustion of fuel.

In some embodiments, the alternator 320 is a component that converts a mechanical energy or mechanical force into an electrical energy. In one configuration, the alternator 320 is coupled to the engine 310 through the drive coupling 315. According to the speed of rotation of the drive coupling 315, the alternator 320 can generate one or more AC voltages 325A . . . 325N. For example, a phase or a frequency of the one or more AC voltages 325 can correspond to the speed of the rotation of the drive coupling 315. The one or more AC voltages 325 can be provided to the configurable power converter 130 to charge the DC power source 120 (or battery).

FIG. 4 is a schematic diagram of a configurable power converter circuit 400. The configurable power converter circuit 400 can be the configurable power converter circuit 230 of FIG. 2. In some embodiments, the configurable power converter circuit 400 includes a first set of switches SW1-SW6, a second set of switches CSW1-CSW5, inductors L1-L3, and capacitors C1-C5. In one aspect, the inductors L1-L3 and the capacitors C1-C5 can constitute or operate as filter components. These components can operate together to convert between the DC voltage 125 at ports PortA1, PortA2 and AC voltages at two or more of ports PortB1, PortB2, PortB3. In one approach, for DC-AC conversion, the configurable power converter circuit 400 can receive the DC voltage 125 at ports PortA1, PortA2 as input ports, and generate AC voltages at two or more of the ports PortB1, PortB2, PortB3 as output ports, according to the pulses 255 applied to the first set of switches SW1-SW6 and the mode control signals 258 applied to the second set of switches CSW1-CSW5. In one approach, for AC-DC conversion, the configurable power converter circuit 400 can receive AC voltages at two or more of the ports PortB1, PortB2, PortB3 as input ports, and generate DC voltage 125 at ports PortA1, PortA2 as output ports, according to the pulses 255 applied to the first set of switches SW1-SW6 and the mode control signals 258 applied to the second set of switches CSW1-CSW5. The first set of switches SW1-SW6 and the second set of switches CSW1-CSW5 can be embodied as transistors (e.g., metal-oxide-semiconductor field-effect transistor), contactors, or any electrical components that can electrically couple or decouple. In some embodiments, the configurable power converter circuit 400 includes more, fewer, or different components than shown in FIG. 4.

In one configuration, the switch SW1 is coupled between the port PortA1 and a node N1, and the switch SW2 is coupled between the port PortA2 and the node N1. In one configuration, the switch SW3 is coupled between the port PortA1 and a node N2, and the switch SW4 is coupled between the port PortA2 and the node N2. In one configuration, the switch SW5 is coupled between the port PortA1 and a node N3, and the switch SW6 is coupled between the port PortA2 and the node N3.

In one configuration, the capacitor C1 is coupled between the port PortA1 and a node N4, and the capacitor C2 is coupled between the port PortA2 and the node N4. In one configuration, the capacitor C3 is coupled between the port PortB1 and the port PortB3, and the capacitor C4 is coupled between the port PortB2 and the port PortB3.

In one configuration, the inductor L1 is coupled between the node N1 and the port PortB1, and the inductor L2 is coupled between the node N2 and the port PortB2. In one configuration, the inductor L3 is coupled between the switches CSW1, CSW3, where the switch CSW1 is coupled between the node N3 and a first end of the inductor L3 and the switch CSW3 is coupled between the port PortB3 and a second end of the inductor L3. In one configuration, the switch CSW2 is coupled between the node N4 and the first end of the inductor L3. In one configuration, the capacitor C5 and the switches CSW4, CSW5 are coupled in series between the port PortB1 and the port PortB2.

In some embodiments, the configurable power converter circuit 400 includes or is coupled to sensors V1, V2, V3, A1, A2, A3. The sensors V1, V2, V3, A1, A2, A3 can be part of the sensor device 280. The sensor V1 is a voltage sensor that can detect a voltage at the port PortA1 or a voltage between ports PortA1, PortA2. The sensor V2 is a voltage sensor that can detect a voltage at the port PortB1. The sensor V3 is a voltage sensor that can detect a voltage at the port PortB2. The sensor A1 is a current sensor that can detect a current through the inductor L1 or the port PortB1. The sensor A2 is a current sensor that can detect a current through the inductor L2 or the port PortB2. The sensor A3 is a current sensor that can detect a current through the inductor L3 or the port PortB3. Based on sensor measurements from one or more of the sensors V1, V2, V3, A1, A2, A3, calibration, protection, diagnostic, or metering, according to the selected configuration mode of the configurable power converter circuit 400. For example, the controller 250 can omit or bypass analyzing voltage and/or current of nodes or ports coupled to or associated with disabled switches CSW, according to the configuration mode of the configurable power converter circuit 400.

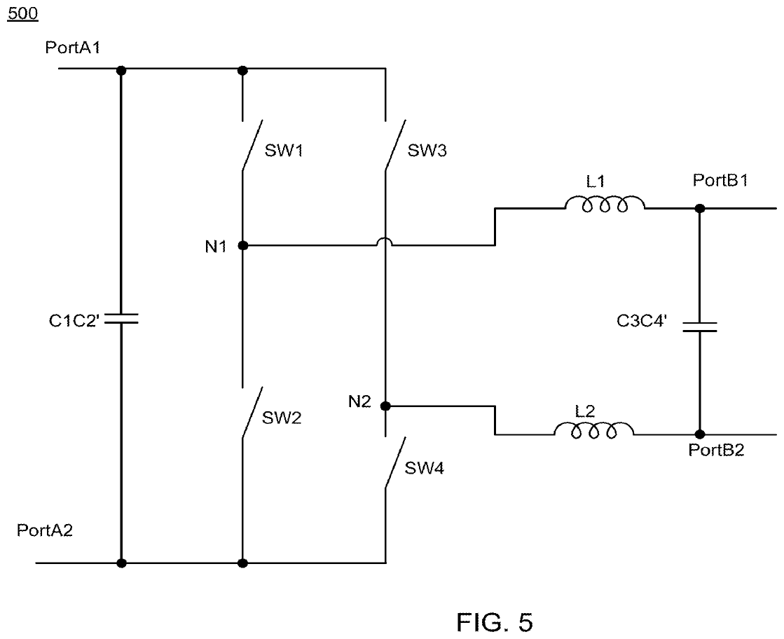

In one aspect, the configurable power converter circuit 400 is operable in various configuration modes, according to the mode control signal 258. In a first configuration mode, the switches CSW1-CSW5 can be disabled according to the mode control signal 258, such that the configurable power converter circuit 400 can be electrically arranged in an equivalent circuit 500 as shown in FIG. 5. For DC-AC conversion, in the first configuration mode, the switches SW1-SW4 can be toggled according to the pulses 255 to generate a single phase AC voltage at the ports PortB1, PortB2, based on a DC voltage at the ports PortA1, PortA2. For AC-DC conversion (or charging a battery), in the first configuration mode, the switches SW1-SW4 can be toggled according to the pulses 255 to generate a DC voltage at the ports PortA1, PortA2, based on a single phase AC voltage at the ports PortB1, PortB2.

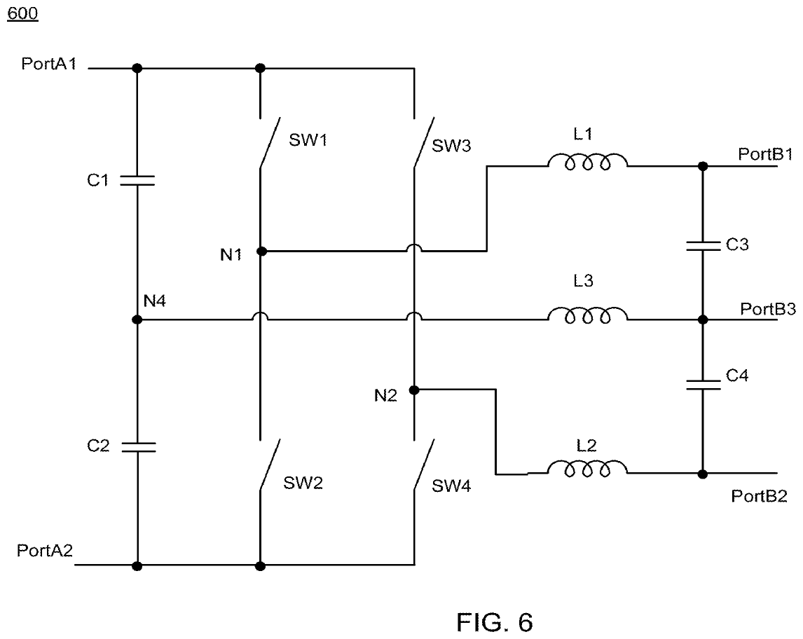

In a second configuration mode, the switches CSW1, CSW4, CSW5 can be disabled and the switches CSW2, CSW3 can be enabled according to the mode control signal 258, such that the configurable power converter circuit 400 can be electrically arranged in an equivalent circuit 600 as shown in FIG. 6. For DC-AC conversion, in the second configuration mode, the switches SW1-SW4 can be toggled according to the pulses 255 to generate split phase (or two-phase) AC voltages at the ports PortB1, PortB2, PortB3, based on a DC voltage at the ports PortA1, PortA2. For AC-DC conversion, in the second configuration mode, the switches SW1-SW4 can be toggled according to the pulses 255 to generate a DC voltage at the ports PortA1, PortA2, based on split phase (or two-phase) AC voltages at the ports PortB1, PortB2, PortB3.

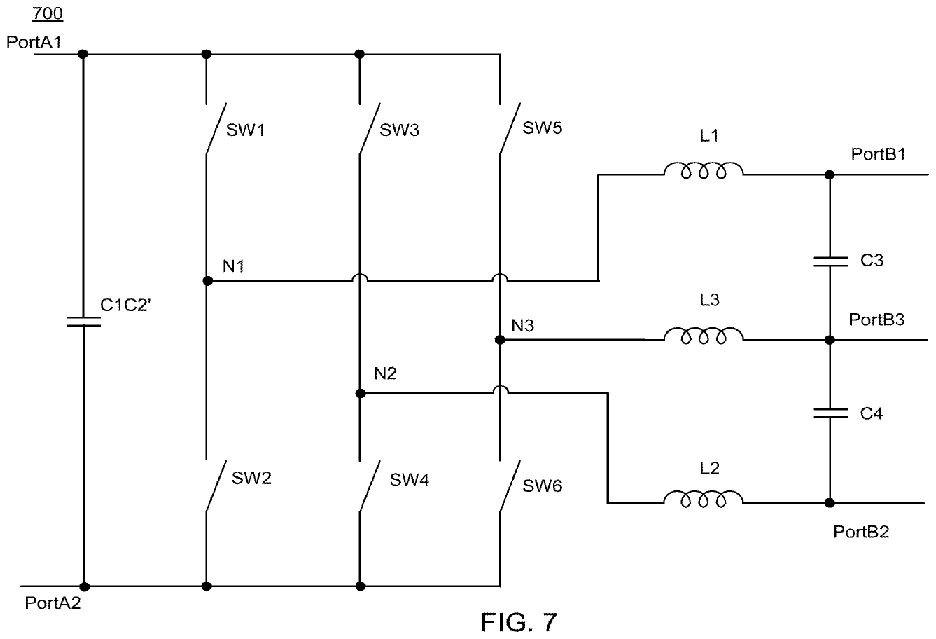

In a third configuration mode, the switches CSW2, CSW4, CSW5 can be disabled and the switches CSW1, CSW3 can be enabled according to the mode control signal 258, such that the configurable power converter circuit 400 can be electrically arranged in an equivalent circuit 700 as shown in FIG. 7. For DC-AC conversion, in the third configuration mode, the switches SW1-SW6 can be toggled according to the pulses 255 to generate split phase (or two-phase) AC voltages at the ports PortB1, PortB2, PortB3, based on a DC voltage at the ports PortA1, PortA2. For AC-DC conversion, in the third configuration mode, the switches SW1-SW6 can be toggled according to the pulses 255 to generate a DC voltage at the ports PortA1, PortA2, based on split phase (or two-phase) AC voltages at the ports PortB1, PortB2, PortB3.

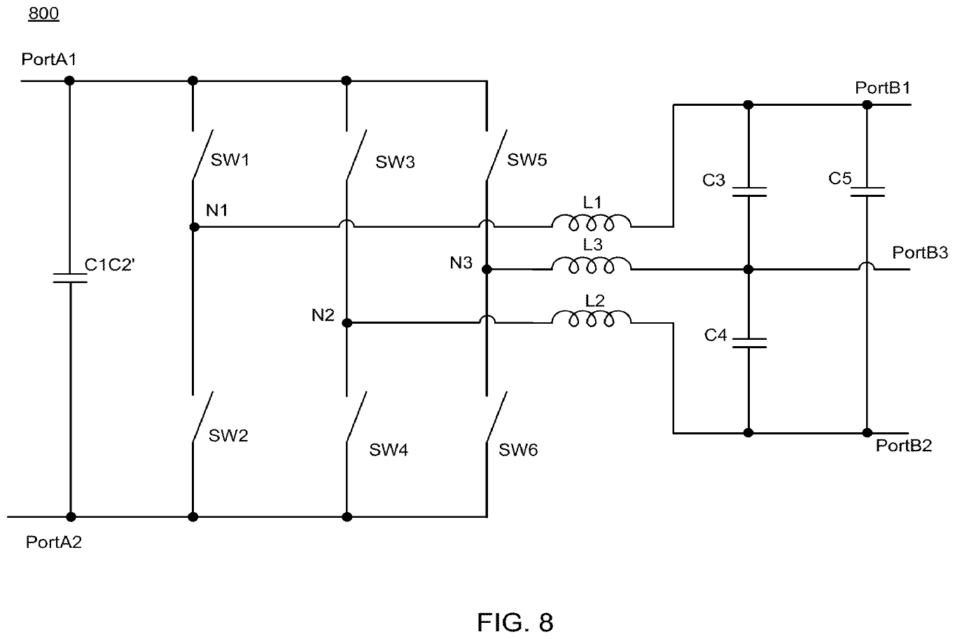

In a fourth configuration mode, the switch CSW2 can be disabled and the switches CSW1, CSW3, CSW4, CSW5 can be enabled according to the mode control signal 258, such that the configurable power converter circuit 400 can be electrically arranged in an equivalent circuit 800 as shown in FIG. 8. For DC-AC conversion, in the fourth configuration mode, the switches SW1-SW6 can be toggled according to the pulses 255 to generate three-phase AC voltages (e.g., 208VRMS or 480VRMS) at the ports PortB1, PortB2, PortB3 for a balanced load, based on a DC voltage at the ports PortA1, PortA2. For AC-DC conversion, in the fourth configuration mode, the switches SW1-SW6 can be toggled according to the pulses 255 to generate a DC voltage at the ports PortA1, PortA2, based on three-phase AC voltages (e.g., 208VRMS or 480VRMS) at the ports PortB1, PortB2, PortB3 for a balanced load.

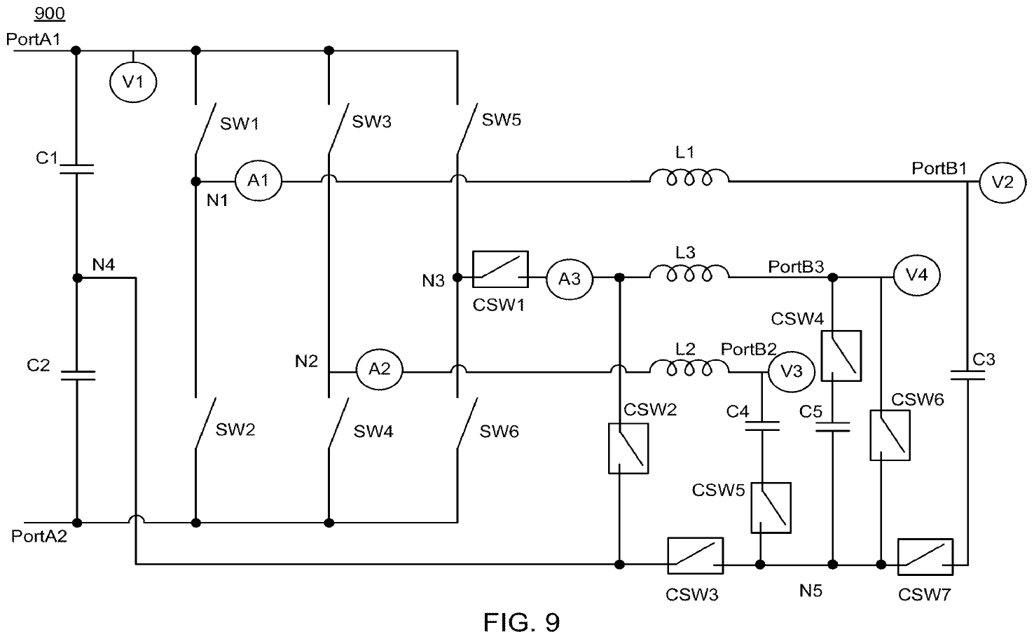

FIG. 9 is a schematic diagram of a configurable power converter circuit 900. The configurable power converter circuit 900 can be the configurable power converter circuit 230 of FIG. 2. In some embodiments, the configurable power converter circuit 900 includes a first set of switches SW1-SW6, a second set of switches CSW1-CSW7, inductors L1-L3, and capacitors C1-C5. In one aspect, the inductors L1-L3 and the capacitors C1-C5 can constitute or operate as filter components. These components can operate together to convert between the DC voltage 125 at ports PortA1, PortA2 and AC voltages at two or more of ports PortB1, PortB2, PortB3. In one approach, for DC-AC conversion, the configurable power converter circuit 900 can receive the DC voltage 125 at ports PortA1, PortA2, and generate AC voltages at two or more of the ports PortB1, PortB2, PortB3, according to the pulses 255 applied to the first set of switches SW1-SW6 and the mode control signals 258 applied to the second set of switches CSW1-CSW7. In one approach, for AC-DC conversion, the configurable power converter circuit 900 can receive AC voltages at two or more of the ports PortB1, PortB2, PortB3, and generate the DC voltage 125 at ports PortA1, PortA2, according to the pulses 255 applied to the first set of switches SW1-SW6 and the mode control signals 258 applied to the second set of switches CSW1-CSW7. The first set of switches SW1-SW6 and the second set of switches CSW1-CSW7 can be embodied as transistors (e.g., metal-oxide-semiconductor field-effect transistor), contactors, or any electrical components that can electrically couple or decouple. In some embodiments, the configurable power converter circuit 900 includes more, fewer, or different components than shown in FIG. 9.

In one configuration, the switch SW1 is coupled between the port PortA1 and a node N1, and the switch SW2 is coupled between the port PortA2 and the node N1. In one configuration, the switch SW3 is coupled between the port PortA1 and a node N2, and the switch SW4 is coupled between the port PortA2 and the node N2. In one configuration, the switch SW5 is coupled between the port PortA1 and a node N3, and the switch SW6 is coupled between the port PortA2 and the node N3.

In one configuration, the capacitor C1 is coupled between the port PortA1 and a node N4, and the capacitor C2 is coupled between the port PortA2 and the node N4. In one configuration, the capacitor C3 is coupled in series with the switch CSW7 between the port PortB1 and a node N5. In one configuration, the capacitor C4 is coupled in series with the switch CSW5 between the port PortB2 and the node N5. In one configuration, the capacitor C5 is coupled in series with the switch CSW4 between the port PortB3 and the node N5. In one configuration, the switch CSW6 is coupled between the port PortB3 and the node N5. In one configuration, the switch CSW3 is coupled between the node N4 and the node N5. In one configuration, the switch CSW1 is coupled between the node N3 and the inductor L3. In one configuration, the switch CSW2 is coupled between the node N4 and the inductor L3.

In one configuration, the inductor L1 is coupled between the node N1 and the port PortB1, and the inductor L2 is coupled between the node N2 and the port PortB2. In one configuration, a first end of the inductor L3 is coupled to the switches CSW1, CSW2, and a second end of the inductor L3 is coupled to the port PortB3.

In some embodiments, the configurable power converter circuit 900 includes or is coupled to sensors V1, V2, V3, V4, A1, A2, A3. The sensors V1, V2, V3, V4, A1, A2, A3 can be part of the sensor device 280. The sensor V1 is a voltage sensor that can detect a voltage at the port PortA1 or a voltage between ports PortA1, PortA2. The sensor V2 is a voltage sensor that can detect a voltage at the port PortB1. The sensor V3 is a voltage sensor that can detect a voltage at the port PortB2. The sensor V4 is a voltage sensor that can detect a voltage at the port PortB3. The sensor A1 is a current sensor that can detect a current through the inductor L1 or the port PortB1. The sensor A2 is a current sensor that can detect a current through the inductor L2 or the port PortB2. The sensor A3 is a current sensor that can detect a current through the inductor L3 or the port PortB3. Based on sensor measurements from one or more of the sensors V1, V2, V3, V4, A1, A2, A3, calibration, protection, diagnostic, or metering, according to the selected configuration mode of the configurable power converter circuit 900. For example, the controller 250 can omit or bypass analyzing voltage and/or current of nodes or ports coupled to or associated with disabled switches CSW, according to the configuration mode of the configurable power converter circuit 900.

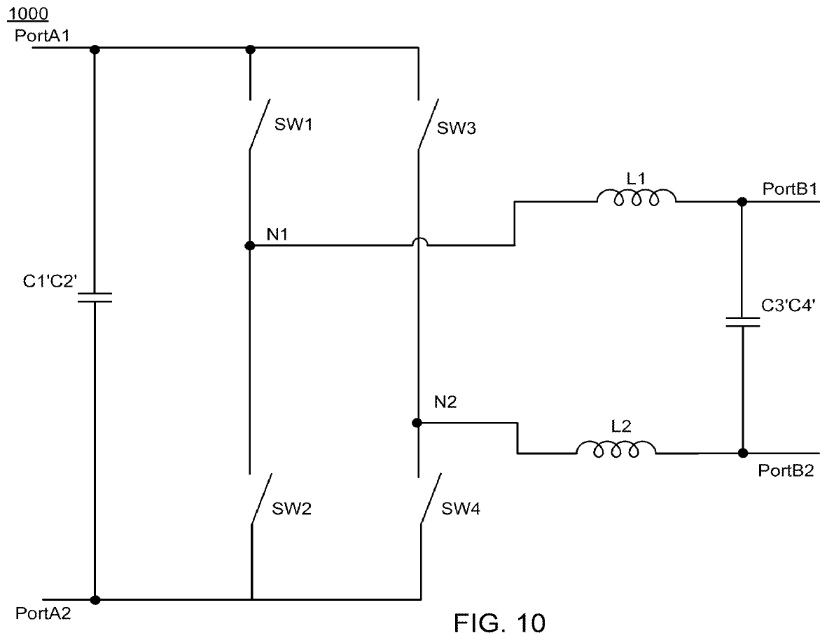

In one aspect, the configurable power converter circuit 900 is operable in various configuration modes, according to the mode control signal 258. In a first configuration mode, the switches CSW1-CSW4 and CSW6 can be disabled and the switches CSW5 and CSW7 can be enabled according to the mode control signal 258, such that the configurable power converter circuit 900 can be electrically arranged in an equivalent circuit 1000 as shown in FIG. 10. In one approach, for DC-AC conversion, in the first configuration mode, the switches SW1-SW4 can be toggled according to the pulses 255 to generate a single phase AC voltage at the ports PortB1, PortB2, based on a DC voltage at the ports PortA1, PortA2. In one approach, for AC-DC conversion, in the first configuration mode, the switches SW1-SW4 can be toggled according to the pulses 255 to generate a DC voltage at the ports PortA1, PortA2, based on a single phase AC voltage at the ports PortB1, PortB2.

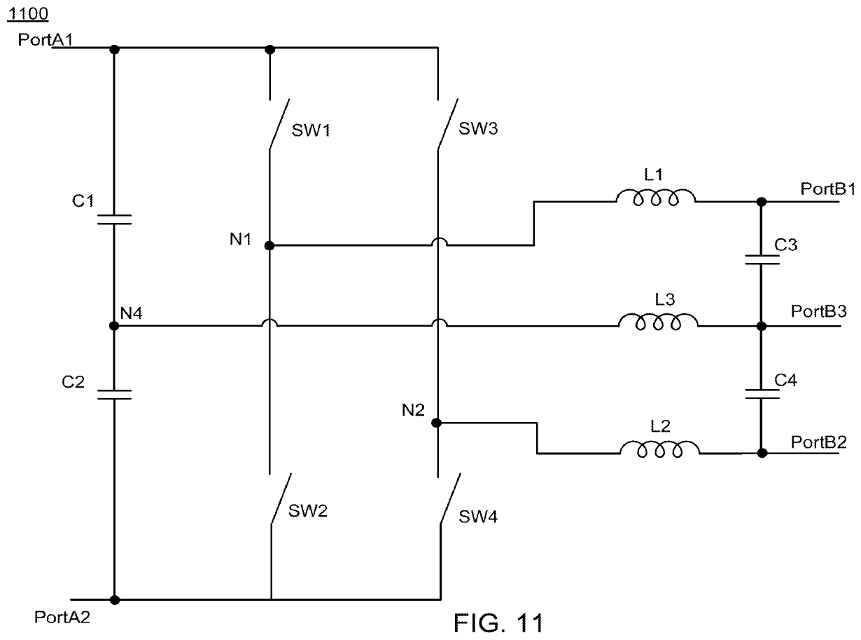

In a second configuration mode, the switches CSW1, CSW3, CSW4 can be disabled and the switches CSW2, CSW5, CSW6, CSW7 can be enabled according to the mode control signal 258, such that the configurable power converter circuit 900 can be electrically arranged in an equivalent circuit 1100 as shown in FIG. 11. For DC-AC conversion, in the second configuration mode, the switches SW1-SW4 can be toggled according to the pulses 255 to generate split phase (or two-phase) AC voltages at the ports PortB1, PortB2, PortB3, based on a DC voltage at the ports PortA1, PortA2. For AC-DC conversion, in the second configuration mode, the switches SW1-SW4 can be toggled according to the pulses 255 to generate a DC voltage at the ports PortA1, PortA2, based on split phase (or two-phase) AC voltages at the ports PortB1, PortB2, PortB3.

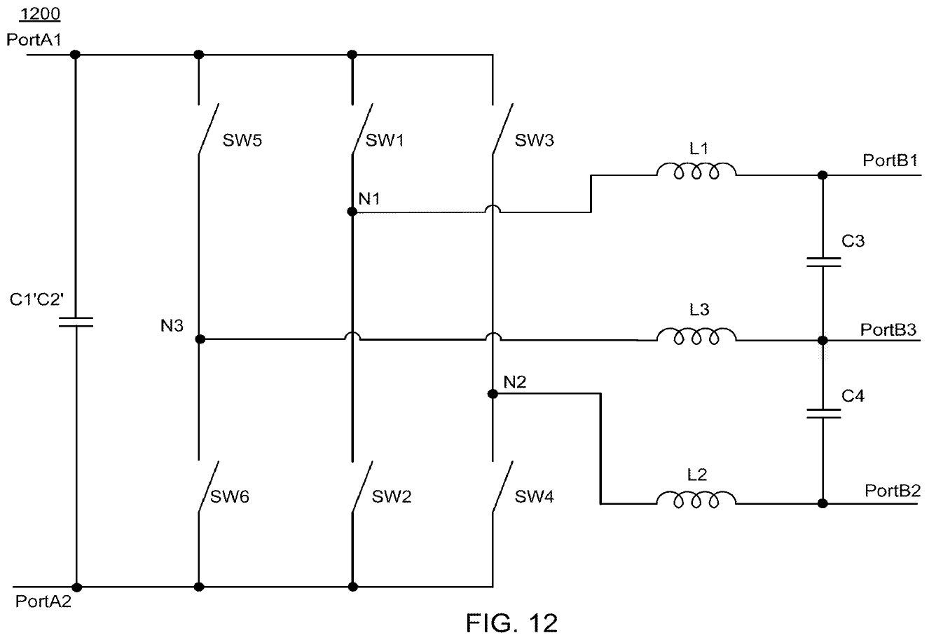

In a third configuration mode, the switches CSW2-CSW4 can be disabled and the switches CSW1, CSW5, CSW6, CSW7 can be enabled according to the mode control signal 258, such that the configurable power converter circuit 900 can be electrically arranged in an equivalent circuit 1200 as shown in FIG. 12. For DC-AC conversion, in the third configuration mode, the switches SW1-SW6 can be toggled according to the pulses 255 to generate split phase (or two-phase) AC voltages at the ports PortB1, PortB2, PortB3, based on a DC voltage at the ports PortA1, PortA2. For AC-DC conversion, in the third configuration mode, the switches SW1-SW6 can be toggled according to the pulses 255 to generate a DC voltage at the ports PortA1, PortA2, based on split phase (or two-phase) AC voltages at the ports PortB1, PortB2, PortB3.

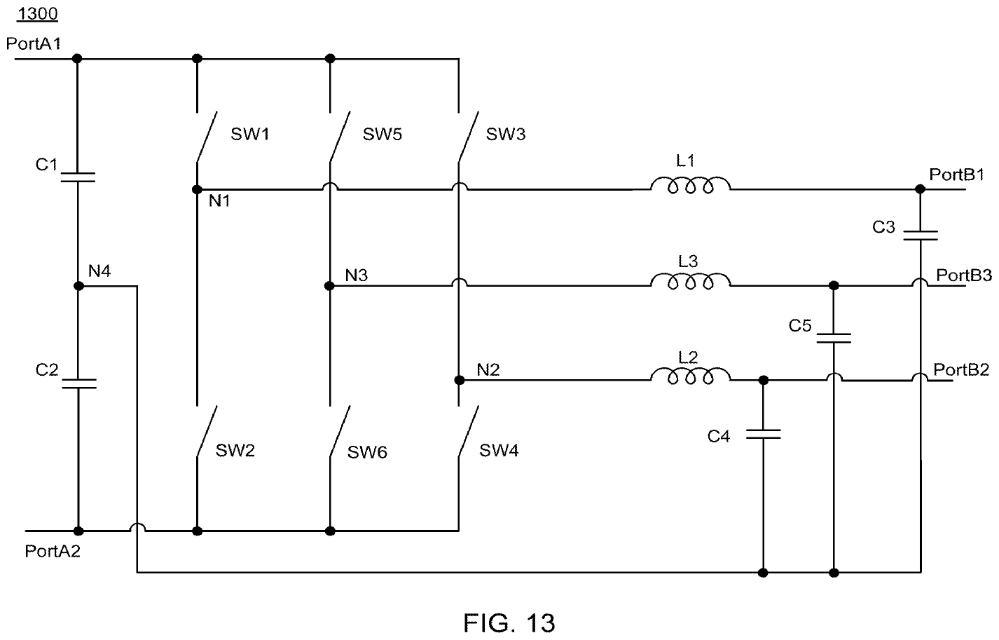

In a fourth configuration mode, the switches CSW2, CSW6 can be disabled and the switches CSW1, CSW3, CSW4, CSW5, CSW7 can be enabled according to the mode control signal 258, such that the configurable power converter circuit 900 can be electrically arranged in an equivalent circuit 1300 as shown in FIG. 13. For DC-AC conversion, in the fourth configuration mode, the switches SW1-SW6 can be toggled according to the pulses 255 to generate three-phase AC voltages (e.g., 208VRMS or 480VRMS) at the ports PortB1, PortB2, PortB3 for a balanced load, based on a DC voltage at the ports PortA1, PortA2. For AC-DC conversion, in the fourth configuration mode, the switches SW1-SW6 can be toggled according to the pulses 255 to generate a DC voltage at the ports PortA1, PortA2, based on three-phase AC voltages (e.g., 208VRMS or 480VRMS) at the ports PortB1, PortB2, PortB3 for a balanced load.

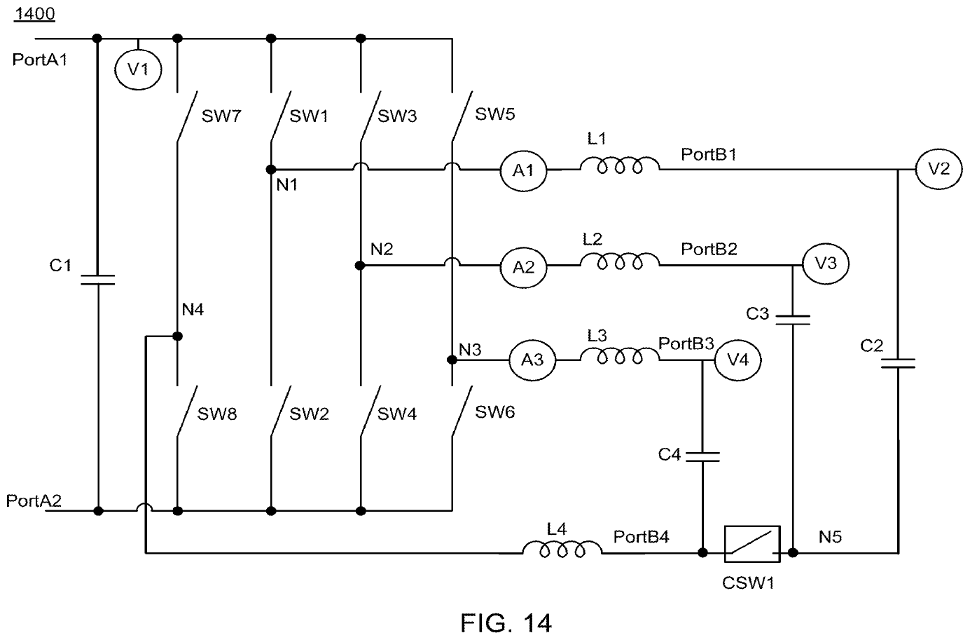

FIG. 14 is a schematic diagram of a configurable power converter circuit 1400. The configurable power converter circuit 1400 can be the configurable power converter circuit 230 of FIG. 2. In some embodiments, the configurable power converter circuit 1400 includes a first set of switches SW1-SW8, a switch CSW1, inductors L1-L4, and capacitors C1-C4. In one aspect, the inductors L1-L4 and the capacitors C1-C4 can constitute or operate as filter components. These components can operate together to convert between the DC voltage 125 at ports PortA1, PortA2 and AC voltages at two or more of ports PortB1, PortB2, PortB3, PortB4. In one approach, for DC-AC conversion, the configurable power converter circuit 1400 can receive the DC voltage 125 at ports PortA1, PortA2, and generate AC voltages at two or more of the ports PortB1, PortB2, PortB3, PortB4, according to the pulses 255 applied to the first set of switches SW1-SW8 and the mode control signal 258 applied to the switch CSW1. In one approach, for AC-DC conversion, the configurable power converter circuit 1400 can receive AC voltages at two or more of the ports PortB1, PortB2, PortB3, PortB4, and generate the DC voltage 125 at ports PortA1, PortA2, according to the pulses 255 applied to the first set of switches SW1-SW8 and the mode control signal 258 applied to the switch CSW1. The first set of switches SW1-SW8 and the switch CSW1 can be embodied as transistors (e.g., metal-oxide semiconductor field-effect transistor), contactors, or any electrical components that can electrically couple or decouple. In some embodiments, the configurable power converter circuit 1400 includes more, fewer, or different components than shown in FIG. 14.

In some embodiments, the configurable power converter circuit 1400 includes or is coupled to sensors V1, V2, V3, V4, A1, A2, A3. The sensors V1, V2, V3, V4, A1, A2, A3 can be part of the sensor device 280. The sensor V1 is a voltage sensor that can detect a voltage at the port PortA1 or a voltage between ports PortA1, PortA2. The sensor V2 is a voltage sensor that can detect a voltage at the port PortB1. The sensor V3 is a voltage sensor that can detect a voltage at the port PortB2. The sensor V4 is a voltage sensor that can detect a voltage at the port PortB3. The sensor A1 is a current sensor that can detect a current through the inductor L1 or the port PortB1. The sensor A2 is a current sensor that can detect a current through the inductor L2 or the port PortB2. The sensor A3 is a current sensor that can detect a current through the inductor L3 or the port PortB3. Based on sensor measurements from one or more of the sensors V1, V2, V3, V4, A1, A2, A3, calibration, protection, diagnostic, or metering, according to the selected configuration mode of the configurable power converter circuit 1400. For example, the controller 250 can omit or bypass analyzing voltage and/or current of nodes or ports coupled to or associated with disabled switches CSW, according to the configuration mode of the configurable power converter circuit 1400.

In one configuration, the switch SW1 is coupled between the port PortA1 and a node N1, and the switch SW2 is coupled between the port PortA2 and the node N1. In one configuration, the switch SW3 is coupled between the port PortA1 and a node N2, and the switch SW4 is coupled between the port PortA2 and the node N2. In one configuration, the switch SW5 is coupled between the port PortA1 and a node N3, and the switch SW6 is coupled between the port PortA2 and the node N3. In one configuration, the switch SW7 is coupled between the port PortA1 and a node N4, and the switch SW8 is coupled between the port PortA2 and the node N4.

In one configuration, the capacitor C1 is coupled between the port PortA1 and the port PortA2. In one configuration, the capacitor C2 is coupled between the port PortB1 and a node N5. In one configuration, the capacitor C3 is coupled between the port PortB2 and the node N5. In one configuration, the capacitor C4 is coupled between the port PortB3 and the port PortB4.

In one configuration, the inductor L1 is coupled between the node N1 and the port PortB1, and the inductor L2 is coupled between the node N2 and the port PortB2. In one configuration, the inductor L3 is coupled between the node N3 and the port PortB3, and the inductor L4 is coupled between the node N4 and the port PortB4.

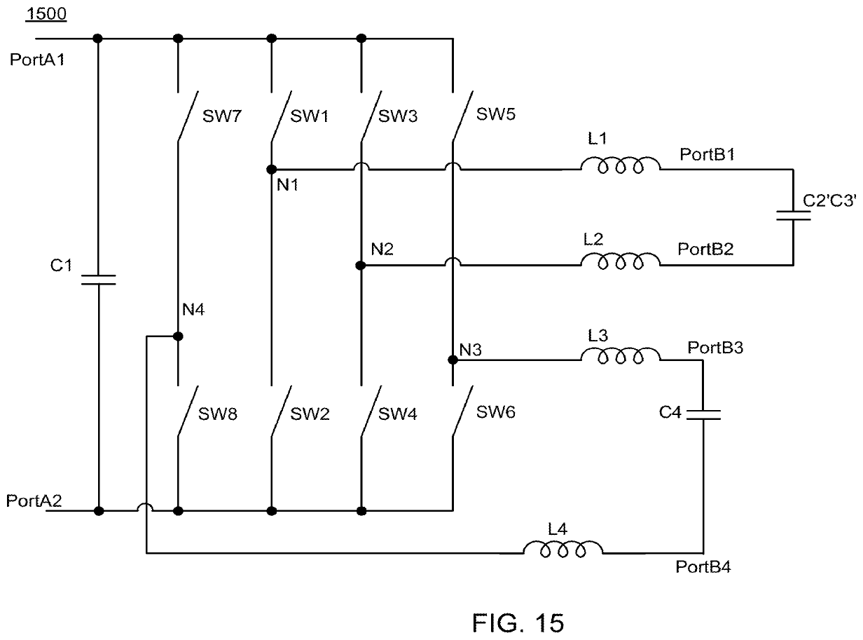

In one aspect, the configurable power converter circuit 1400 is operable in various configuration modes, according to the mode control signal 258. In a first configuration mode, the switch CSW1 can be disabled according to the mode control signal 258, such that the configurable power converter circuit 1400 can be electrically arranged in an equivalent circuit 1500 as shown in FIG. 15. For DC-AC conversion, in the first configuration mode, the switches SW1-SW8 can be toggled according to the pulses 255 to generate a single phase AC voltage at the ports PortB1, PortB2, and generate a single phase AC voltage at the ports PortB3, PortB4, based on a DC voltage at the ports PortA1, PortA2. For AC-DC conversion, in the first configuration mode, the switches SW1-SW8 can be toggled according to the pulses 255 to generate a DC voltage at the ports PortA1, PortA2, based on a single phase AC voltage at the ports PortB1, PortB2, and/or a single phase AC voltage at the ports PortB3, PortB4.

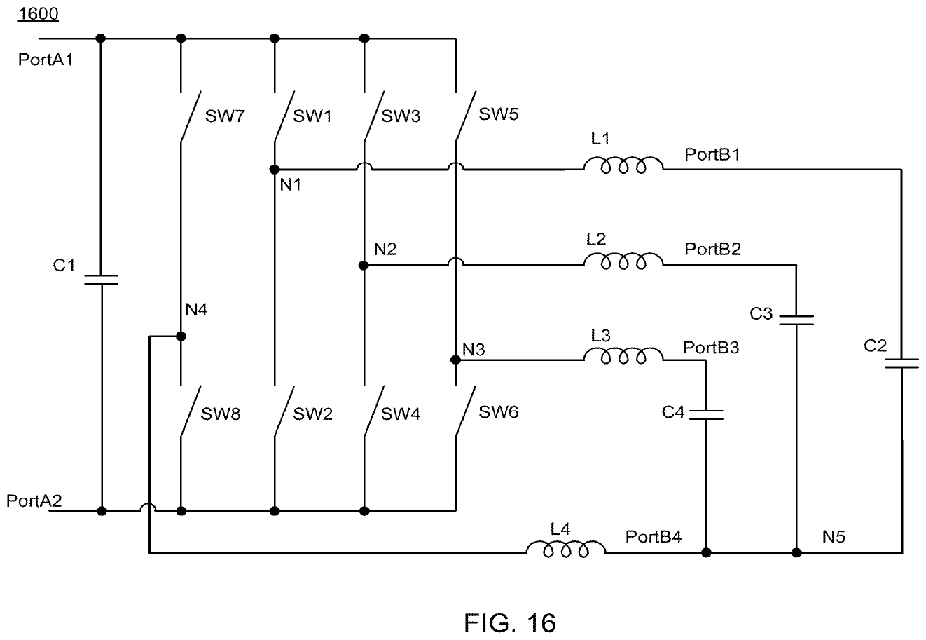

In a second configuration mode, the switch CSW1 can be enabled according to the mode control signal 258, such that the configurable power converter circuit 1400 can be electrically arranged in an equivalent circuit 1600 as shown in FIG. 16. For DC-AC conversion, in the second configuration mode, the switches SW1-SW8 can be toggled according to the pulses 255 to generate three-phase AC voltages (e.g., 208VRMS or 480VRMS) at the ports PortB1, PortB2, PortB3, PortB4 for an unbalanced load, based on a DC voltage at the ports PortA1, PortA2. For AC-DC conversion, in the second configuration mode, the switches SW1-SW8 can be toggled according to the pulses 255 to generate a DC voltage at the ports PortA1, PortA2, based on three-phase AC voltages (e.g., 208VRMS or 480VRMS) at the ports PortB1, PortB2, PortB3, PortB4 for an unbalanced load.

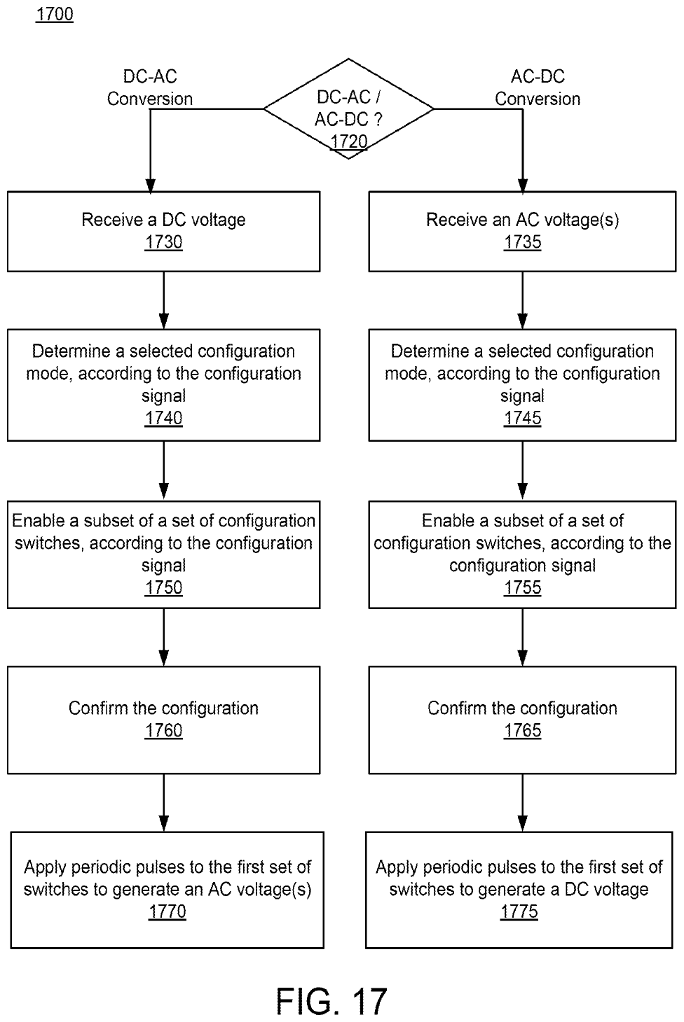

FIG. 17 shows a method 1700 of converting between a DC power and an AC power. In some embodiments, the method 1700 is performed by the configurable power converter 130. The configurable power converter 130 can be coupled to a genset or implemented as part of the genset. In some embodiments, the method 1700 is performed by any electric component for DC-AC power conversion or AC-DC power conversion. In some embodiments, the method 1700 includes more, fewer, or different components than shown in FIG. 17. For example, the method 1700 lacks steps 1720, 1730, 1740, 1750, 1760, 1770 in some embodiments. For example, the method 1700 lacks steps 1720, 1735, 1745, 1755, 1765, 1775, in some embodiments. For example, the method 1700 lacks steps 1760, 1765, in some embodiments.

In one approach, the configurable power converter 130 determines 1720 whether the configurable power converter is operating in a DC-AC conversion mode or in an AC-DC conversion mode. In one configuration, the configurable power converter 130 includes or is coupled to a DC power source 120 at a first set of ports (e.g., PortA). In one configuration, the configurable power converter 130 can be adaptively coupled to a power grid, a load device, or a generator set at a second set of ports (e.g., PortB). The configurable power converter 130 can automatically determine whether the configurable power converter 130 is operating in the DC-AC conversion mode or in the AC-DC conversion mode, by detecting which component is connected to the configurable power converter 130. Alternatively or additionally, the configurable power converter 130 can determine whether the configurable power converter 130 is operating in the DC-AC conversion mode or in the AC-DC conversion mode, based on a user selection or an external input.

In one approach, the configurable power converter 130 can automatically determine whether the configurable power converter is operating in the DC-AC conversion mode or AC-DC conversion mode. The configurable power converter 130 can include one or more sensors (e.g., sensor device 280) that can determine whether the genset 160 is coupled to the second set of ports of the configurable power converter 130. In response to detecting that the second set of ports is disconnected from the genset 160 and one or more of the second set of ports are connected to the power grid or load device, the controller 250 of the configurable power converter 130 can automatically determine that the configurable power converter 130 is operating in the DC-AC conversion mode to provide AC voltages at the one or more of the second set of ports. In response to detecting that one or more of the second set of ports are connected to the genset 160, the controller 250 of the configurable power converter 130 can automatically determine that the configurable power converter 130 is operating in the AC-DC conversion mode (or charging mode).

In one approach, the configurable power converter 130 can determine whether the configurable power converter is operating in the DC-AC conversion mode or AC-DC conversion mode, based on an operating mode signal 245 indicating the operating mode (e.g., DC-AC conversion mode or AC-DC conversion mode). In one implementation, the configurable power converter 130 includes or is coupled to an input device 265, and receives an operating mode signal 245A from the input device 265. Alternatively or additionally, the configurable power converter 130 includes or is coupled to the communication interface 260, and receives an operating mode signal 245B from the communication interface 260.

The input device 265 can be a device that receives the user selection 115, and generates an operating mode signal 245A, according to the user selection 115. Examples of the input device 265 include a button, a turn dial, a touch pad, a touch display device, a set of switches, or any device that can generate an electrical signal according to the user selection 115. The user can manually touch, press, or configure the input device 265 to select a desired operating mode. The input device 265 can generate an operating mode signal 245A corresponding to the selected operating mode, and provide the operating mode signal 245A to the controller 250.

The communication interface 260 is a device that can connect to the network 150 to communicate with the remote server 170, the user device 180, or other devices. The communication interface 260 can receive an operating mode message or a configuration message from the remote server 170 or the user device 180, and generate an operating mode signal 245B according to the operating mode message. The communication interface 260 can receive the operating mode message, and downconvert or decode the operating mode message to generate the operating mode signal 245B. The communication interface 260 can output or provide the operating mode signal 245B to the controller 250.

In one approach, the configurable power converter 130 receives 1730 a DC voltage 125. The configurable power converter 130 can receive the DC voltage 125 from the DC power source 120, in response to determining that the configurable power converter 130 is operating in a DC-AC conversion mode.

In one approach, the configurable power converter 130 determines 1740, from a set of configuration modes of the configurable power converter 130, a selected configuration mode. The selected configuration mode may be indicated by a configuration signal 240. The configurable power converter 130 may receive or obtain the configuration signal 240 through the input device 265 or the communication interface 260, and determine the selected configuration mode indicated by the configuration signal 240. For example, the user can manually touch, press, or configure the input device 265 to select a desired configuration mode. The input device 265 can generate the configuration signal 240A corresponding to the selected configuration, and output or provide the configuration signal 240A to the controller 250. For example, the communication interface 260 can receive a configuration message 262 from the remote server 170 or the user device 180, and generate a configuration signal 240B according to the configuration message 262. The communication interface 260 can receive the configuration message 262, and downconvert or decode the configuration message 262 to generate the configuration signal 240B. The communication interface 260 can output or provide the configuration signal 240B to the controller 250.

In one approach, the configurable power converter 130 enables 1750 a subset of a set of configuration switches, according to the configuration signal. In one aspect, the controller 250 receives the configuration signal 240A or the configuration signal 240B, and generates the mode control signals 258, according to the configuration signal 240A or the configuration signal 240B. The controller 250 can determine which switch(es) (e.g., CSW) of the configurable power converter circuit 230 to enable and which switch(es) (e.g., CSW) of the configurable power converter circuit 230 to disable, according to a selected configuration mode as indicated by the configuration signal 240A or the configuration signal 240B. The controller 250 can generate the mode control signals 258, according to the determination on which switches to enable and which switches to disable. The controller 250 can apply the mode control signals 258 to the configurable power converter circuit 230 to electrically arrange various components of the configurable power converter circuit 230 in the selected configuration mode.

In one approach, the configurable power converter 130 confirms 1760 the configuration. The configurable power converter 130 may monitor, through one or more sensor devices, a voltage or current at one or more of the first set of ports (e.g., PortA) or one or more of the second set of ports (e.g., PortB). According to the monitored voltage or current, the configurable power converter 130 may perform a calibration, a protection, a diagnostic, or a metering to ensure that the configurable power converter 130 is correctly set in the selected configuration mode.

In one approach, the configurable power converter 130 applies 1770 periodic pulses 255 to the first set of switches to generate one or more AC voltages at one or more of second set of ports (e.g., PortB). In one aspect, the controller 250 receives the configuration signal 240A or the configuration signal 240B, and generates pulses 255, according to the configuration signal 240A or the configuration signal 240B. The controller 250 can determine one or more parameters (e.g., a frequency, a pulse width, and a number of pulses 255 to output, etc.) of the pulses 255, according to a selected configuration mode as indicated by the configuration signal 240A or the configuration signal 240B, and generate the pulses 255 according to the determined parameters. While various components of the configurable power converter circuit 230 are arranged in the selected configuration mode according to the mode control signals 258, the controller 250 can apply the pulses 255 to the configurable power converter circuit 230 to generate one or more AC voltages 135 based on the DC voltage 125.

In one approach, the configurable power converter 130 receives 1735 one or more AC voltages. The configurable power converter 130 can receive the one or more AC voltages, for example, from the genset 160, in response to determining that the configurable power converter 130 is operating in the AC-DC conversion mode.

In one approach, the configurable power converter 130 determines 1745, from a set of configuration modes of the configurable power converter 130, a selected configuration mode. The selected configuration mode may be indicated by a configuration signal 240 through the input device 265 or the communication interface 260.

In one approach, the configurable power converter 130 enables 1755 a subset of a set of configuration switches, according to the configuration signal. In one aspect, the controller 250 receives the configuration signal 240A or the configuration signal 240B, and generates the mode control signals 258, according to the configuration signal 240A or the configuration signal 240B. The controller 250 can determine which switch(es) (e.g., CSW) of the configurable power converter circuit 230 to enable and which switch(es) (e.g., CSW) of the configurable power converter circuit 230 to disable, according to a selected configuration mode as indicated by the configuration signal 240A or the configuration signal 240B. The controller 250 can generate the mode control signals 258, according to the determination on which switches to enable and which switches to disable. The controller 250 can apply the mode control signals 258 to the configurable power converter circuit 230 to electrically arrange various components of the configurable power converter circuit 230 in the selected configuration mode.

In one approach, the configurable power converter 130 confirms 1765 the configuration. The configurable power converter 130 may monitor, through one or more sensor devices, a voltage or current at one or more of the first set of ports (e.g., PortA) or one or more of the second set of ports (e.g., PortB). According to the monitored voltage or current, the configurable power converter 130 may perform a calibration, a protection, a diagnostic, or a metering to ensure that the configurable power converter 130 is correctly set in the selected configuration mode.

In one approach, the configurable power converter 130 applies 1775 periodic pulses 255 to the first set of switches to generate a DC voltage 125 at the first set of ports (e.g., PortA). In one aspect, the controller 250 receives the configuration signal 240A or the configuration signal 240B, and generates pulses 255, according to the configuration signal 240A or the configuration signal 240B. The controller 250 can determine one or more parameters (e.g., a frequency, a pulse width, and a number of pulses 255 to output, etc.) of the pulses 255, according to a selected configuration mode as indicated by the configuration signal 240A or the configuration signal 240B, and generate the pulses 255 according to the determined parameters. While various components of the configurable power converter circuit 230 are arranged in the selected configuration mode according to the mode control signals 258, the controller 250 can apply the pulses 255 to the configurable power converter circuit 230 to generate the DC voltage 125 based on one or more AC voltages 135 from the genset 160.

### Construction of Example Embodiments

While this specification contains many specific implementation details, these should not be construed as limitations on the scope of what can be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features can be described as acting in certain combinations and even initially claimed as such, one or more features from a claimed combination can, in some cases, be excised from the combination, and the claimed combination can be directed to a subcombination or variation of a subcombination.

As utilized herein, the terms “substantially,” generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled” and the like, as used herein, mean the joining of two components directly or indirectly to one another. Such joining can be stationary (e.g., permanent) or moveable (e.g., removable or releasable). Such joining can be achieved with the two components or the two components and any additional intermediate components being integrally formed as a single unitary body with one another, with the two components, or with the two components and any additional intermediate components being attached to one another.

It is important to note that the construction and arrangement of the system shown in the various example implementations is illustrative only and not restrictive in character. All changes and modifications that come within the spirit and/or scope of the described implementations are desired to be protected. It should be understood that some features cannot be necessary, and implementations lacking the various features can be contemplated as within the scope of the application, the scope being defined by the claims that follow. When the language “a portion” is used, the item can include a portion and/or the entire item unless specifically stated to the contrary.

What is claimed is:

1. A configurable power converter for adaptively converting between a direct current (DC) voltage and an alternating current (AC) voltage, the configurable power converter comprising:
a first set of switches coupled to a first set of ports;
a set of filter components coupled to a second set of ports;
a second set of switches, each of the second set of switches coupled to a corresponding one of the set of filter components or a corresponding one of the second set of ports; and
a controller configured to:
receive a configuration signal indicating a selected configuration mode of the configurable power converter,
enable a subset of the second set of switches, according to the configuration signal, and
apply periodic pulses to the first set of switches to generate one or more AC voltages at one or more of the second set of ports, according to the configuration signal.

2. The configurable power converter of claim 1, wherein the controller is configured to:
disable another subset of the second set of switches, according to the configuration signal, and
apply the periodic pulses to the first set of switches, while the subset of the second set of switches is enabled and the another subset of the second set of switches is disabled.

3. The configurable power converter of claim 1, wherein the selected configuration mode is selected from two or more of:
a first configuration mode, in which two pairs of the first set of switches are periodically toggled to provide a single phase AC voltage at two ports of the second set of ports,
a second configuration mode, in which the two pairs of the first set of switches are periodically toggled to provide a two-phase AC voltage at three ports of the second set of ports,
a third configuration mode, in which three pairs of the first set of switches are periodically toggled to provide another two-phase AC voltage at the three ports of the second set of ports, and
a fourth configuration mode, in which the three pairs of the first set of switches are periodically toggled to provide a three-phase AC voltage at the three ports of the second set of ports.

4. The configurable power converter of claim 1, wherein the selected configuration mode is selected from two or more of:
a first configuration mode, in which first two pairs and second two pairs of the first set of switches are periodically toggled to provide a single phase AC voltage at first two ports of the second set of ports and another single phase AC voltage at second two ports of the second set of ports, and
a second configuration mode, in which the first two pairs and the second two pairs of the first set of switches are periodically toggled to provide a three-phase AC voltage at the first two ports and the second two ports of the second set of ports.

5. The configurable power converter of claim 1, further comprising:
an input device configured to:
receive a user selection of the selected configuration mode from one or more allowable configuration modes, and
generate the configuration signal indicating the selected configuration mode, according to the user selection.

6. The configurable power converter of claim 1, further comprising:
a communication interface configured to:
receive, from a remote device, a configuration message indicating the selected configuration mode, and
decode the configuration message to generate the configuration signal.

7. The configurable power converter of claim 1, wherein the first set of switches includes:
a first switch coupled between a first input port of the first set of ports and a first node,
a second switch coupled between a second input port of the first set of ports and the first node,
a third switch coupled between the first input port and a second node,
a fourth switch coupled between the second input port and the second node,
a fifth switch coupled between the first input port and a third node, and
a sixth switch coupled between the second input port and the third node.

8. The configurable power converter of claim 7, wherein the set of filter components includes:
a first inductor coupled between the first node and a first output port of the second set of ports,
a second inductor coupled between the second node and a second output port of the second set of ports, and
a third inductor coupled between the third node and a third output port of the second set of ports.

9. The configurable power converter of claim 8, further comprising:
a first capacitor coupled between the first input port and a fourth node;
a second capacitor coupled between the second input port and the fourth node;
a third capacitor coupled between the first output port and the third output port;
a fourth capacitor coupled between the second output port and the third output port; and
a fifth capacitor coupled between the first output port and the second output port.

10. The configurable power converter of claim 9, wherein the second set of switches includes:
a first configuration switch coupled between the third node and a first end of the third inductor,
a second configuration switch coupled between the fourth node and the first end of the third inductor,
a third configuration switch coupled between the third output port and a second end of the third inductor, and
a fourth configuration switch coupled between the first output port and the second output port in series with the fifth capacitor.

11. The configurable power converter of claim 8, further comprising:
a first capacitor coupled between the first input port and a fourth node;
a second capacitor coupled between the second input port and the fourth node;
a third capacitor coupled between the first output port and a fifth node;
a fourth capacitor coupled between the second output port and the fifth node; and
a fifth capacitor coupled between the third output port and the fifth node.

12. The configurable power converter of claim 11, wherein the second set of switches includes:
a first configuration switch coupled between the third node and a first end of the third inductor,
a second configuration switch coupled between the first end of the third inductor and the fourth node,
a third configuration switch coupled between the fourth node and the fifth node,
a fourth configuration switch coupled between the third output port and the fifth node in series with the fifth capacitor,
a fifth configuration switch coupled between the second output port and the fifth node in series with the fourth capacitor,
a sixth configuration switch coupled between the third output port and the fifth node, and
a seventh configuration switch coupled between the first output port and the fifth node in series with the third capacitor.

13. The configurable power converter of claim 1, wherein the first set of switches includes:
a first switch coupled between a first input port of the first set of ports and a first node,
a second switch coupled between a second input port of the first set of ports and the first node,
a third switch coupled between the first input port and a second node,
a fourth switch coupled between the second input port and the second node,
a fifth switch coupled between the first input port and a third node,
a sixth switch coupled between the second input port and the third node,
a seventh switch coupled between the first input port and a fourth node, and
an eighth switch coupled between the second input port and the fourth node.

14. The configurable power converter of claim 13, wherein the set of filter components includes:
a first inductor coupled between the first node and a first output port of the second set of ports,
a second inductor coupled between the second node and a second output port of the second set of ports,
a third inductor coupled between the third node and a third output port of the second set of ports, and
a fourth inductor coupled between the fourth node and a fourth output port of the second set of ports.

15. The configurable power converter of claim 14, further comprising:
a first capacitor coupled between the first input port and the second input port;
a second capacitor coupled between the first output port and a fifth node;
a third capacitor coupled between the second output port and the fifth node; and
a fourth capacitor coupled between the third output port and the fourth output port,
wherein the second set of switches includes a configuration switch coupled between the fourth output port and the fifth node.

16. A method of converting between a direct current (DC) power and an alternating current (AC) power by a configurable power converter, the configurable power converter including a set of switches, a set of contactors, a set of filter components, and a controller, the method comprising:
receiving, by a first set of ports of the configurable power converter coupled to the set of switches, a DC voltage;
receiving, by the controller, a configuration signal indicating a selected configuration mode of the configurable power converter;
configuring, by the controller, the set of contactors, according to the configuration signal, configuring the set of contactors including enabling a first subset of the set of contactors and disabling a second subset of the set of contactors; and
toggling, by the controller, the set of switches to generate one or more AC voltages at one or more of a second set of ports, while the set of contactors are configured according to the configuration signal.

17. The method of claim 16, further comprising:
setting, by the controller, a frequency of pulses to toggle the set of switches, according to the configuration signal.

18. The method of claim 16, further comprising:
monitoring, by a sensor device, a voltage or current at one or more of the first set of ports or one or more of the second set of ports; and
performing, by the controller, a calibration, a protection, a diagnostic, or a metering, according to the monitored voltage or current.

19. A system for adaptively providing an alternating current (AC) power based on a direct current (DC) power, the system comprising:
a generator set configured to generate, in a charging mode, an AC voltage at one or more ports; and
a power conversion device coupled to the generator set at the one or more ports, the power conversion device configured to:
generate, in a DC-AC conversion mode, one or more AC voltages at the one or more ports, according to a selected configuration mode, based on a DC voltage from a DC power source, and
charge, in a charging mode, the DC power source based on the AC voltage from the generator set at the one or more ports.

20. The system of claim 19, wherein the power conversion device includes:
a first set of switches,
a set of filter components,
a second set of switches, and
a controller configured to:
enable a subset of the second set of switches, and
apply periodic pulses to the first set of switches to charge the DC power source, while the subset of the second set of switches is enabled.
